(19) United States
(12) Patent Application Publication
(10) Pub. No.: US 2017/0178215 A1
(43) Pub. Date: Jun. 22, 2017

(54) INVENTORY QUERY BASED ON IMAGE CONTENT

(71) Applicant: Checkpoint Systems, Inc., Thorofare, NJ (US)

(72) Inventor: Tracey G. Dwyer, Wayne, NJ (US)

(21) Appl. No.: 14/971,357

(22) Filed: Dec. 16, 2015

(51) Int. Cl. G06Q 30/06; G06K 9/62; G06K 9/52

(52) U.S. Cl. CPC G06Q 30/0625; G06K 9/52; G06K 9/6267

(57) ABSTRACT

An apparatus including processing circuitry is provided configured to perform a method including receiving an image including at least one subject, extracting features of the at least one subject from the image, determining a subject identity based on the features, receiving a user location indication, and causing a target inventory query to be transmitted based on the subject identity and the user location indication.

### TECHNICAL FIELD

Example embodiments generally relate to object recognition and, in particular, relate to causing a target inventory query based on image content.

### BACKGROUND

Typically when a person sees a subject item, e.g., outfit, accessory, product, or the like, of another person, the first person may ask the second person about the subject to ascertain information about the subject and possible purchase locations. It may be awkward for the first person to ask about the subject item, when the second person is a stranger or they do not have a well-established relationship. In other instances it may not be possible to ask the person, such as when subject is in an image in a magazine or a video.

In the absence of directly asking the owner about the subject, the person desiring the subject may look in various stores or perform an online search, based on guesses about a manufacturer, retailer, product name, or the like. Even after determining a possible subject identity, the person may have to look for a retailer which sells the subject and has the subject in stock.

### BRIEF SUMMARY OF SOME EXAMPLES

Accordingly, some example embodiments may provide a mechanism by which to cause a target inventory query based on an subject within an image, as described below. In one example embodiment, an apparatus is provided including processing circuitry configured to receive an image including at least one subject, extracting features of the at least one subject from the image, determining a subject identity based on the features, receiving a user location indication, and causing a target inventory query to be transmitted based on the subject identity and the user location indication.

In another example embodiment, a method is provided including receiving an image including at least one subject, extracting features of the at least one subject from the image, determining an subject identity based on the features, receiving a user location indication, and causing, by processing circuitry, a target inventory query to be transmitted based on the subject identity and the user location indication.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a functional block diagram of a system that may be useful in connection with causing a target inventory query based on content within an image according to an example embodiment;

FIG. 2 illustrates a functional block diagram of an apparatus that may be useful in connection with causing a target inventory query based on content within an image according to an example embodiment;

FIG. 3 illustrates an example image including content according to an example embodiment;

FIGS. 4-6 illustrate user interface renderings in accordance with an example embodiment; and

FIG. 7 illustrates a method of causing a target inventory query based on a subject within an image according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout.

In some examples, an apparatus and method for causing a target inventory query based on content within an image may be provided. An image may be received including at least one subject. Features of one or more subjects within the image may be extracted and used to determine a subject identity. A target inventory query may be transmitted based on the subject identity and the user location and one or more locations of targets received. This may allow the user to capture or load an image and not only determine one or more subjects within the image, but also determine one or more locations at which the subject may be purchased, which have the subject in stock. In some embodiments, closely correlated alternatives to the subject may be provided in addition to or in place the subject within the image.

In some examples, the image may have multiple potential subjects. An indication may be received of a selected subject within the image or the process may be performed in whole or in part for each subject in the image.

In some embodiments, more than one subject identity query result may be returned. The subject identity query results may be compared to the features associated with the subject and a probability score determined. In some embodiments, the subject identity query results may be sorted or displayed based on the probability score. In an example embodiment, retailer or merchants may submit bids which may be used to bias the probability score and/or the display of the subject identity query results.

In an example embodiment, bid information may also include redemption coupons which may be offered to users to encourage purchasing of the subject at a specified location or within a specified time period.

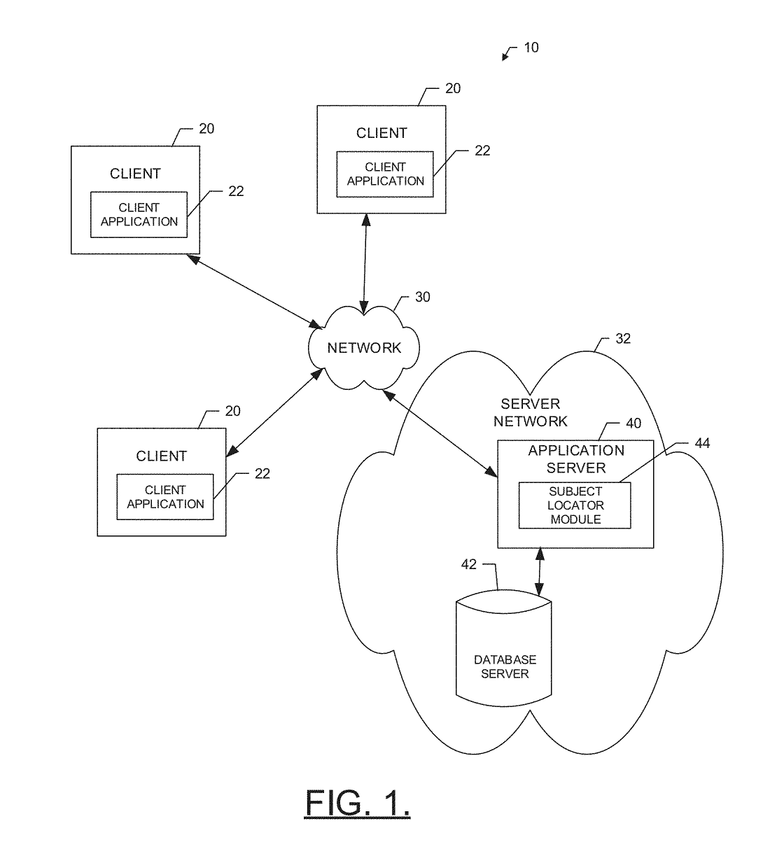

An example embodiment will now be described in reference to FIG. 1, which illustrates an example system in which an example embodiment may be employed. As shown in FIG. 1, a system 10 according to an example embodiment may include one or more client devices (e.g., clients 20). Notably, although FIG. 1 illustrates three clients 20, it should be appreciated that a single client or many more clients 20 may be included in some embodiments and thus, the three clients 20 of FIG. 1 are simply used to illustrate a potential for a multiplicity of clients 20 and the number of clients 20 is in no way limiting to other example embodiments. In this regard, example embodiments are scalable to include of any number of clients 20 being tied into the system 10. Furthermore, in some cases, some embodiments may be practiced on a single client without any connection to the system 10.

The example described herein will be related to a client 20 comprising a mobile computing device in one example embodiment. However, it should be appreciated that example embodiments may also apply to any asset including, for example, any programmable device that is capable of causing a target inventory query based on a subject within an image, as described herein.

Each one of the clients 20 may include or otherwise be embodied as computing device (e.g., a computer, a network access terminal, a personal digital assistant (PDA), cellular phone, smart phone, or the like) capable of communication with a network 30. As such, for example, each one of the clients 20 may include (or otherwise have access to) memory for storing instructions or applications for the performance of various functions and a corresponding processor for executing stored instructions or applications. Each one of the clients 20 may also include software and/or corresponding hardware for enabling the performance of the respective functions of the clients 20 as described below. In an example embodiment, one or more of the clients 20 may include a client application 22 configured to operate in accordance with an example embodiment. In this regard, for example, the client application 22 may include software for enabling a respective one of the clients 20 to communicate with the network 30 for requesting and/or receiving information and/or services via the network 30. Moreover, in some embodiments, the information or services that are requested via the network may be provided in a software as a service (SAS) environment. The information or services receivable at the client applications 22 may include deliverable components (e.g., downloadable software to configure the clients 20, or information for consumption/processing at the clients 20). As such, for example, the client application 22 may include corresponding executable instructions for configuring the client 20 to provide corresponding functionalities for causing a target inventory query based on a subject within an image, as described in greater detail below.

The network 30 may be a data network, such as a local area network (LAN), a metropolitan area network (MAN), a wide area network (WAN) (e.g., the Internet), and/or the like, which may couple the clients 20 to devices such as processing elements (e.g., personal computers, server computers or the like) and/or databases. Communication between the network 30, the clients 20 and the devices or databases (e.g., servers) to which the clients 20 are coupled may be accomplished by either wireline or wireless communication mechanisms and corresponding communication protocols.

In an example embodiment, devices to which the clients 20 may be coupled via the network 30 may include one or more application servers (e.g., application server 40), and/or a database server 42, which together may form respective elements of a server network 32. Although the application server 40 and the database server 42 are each referred to as “servers,” this does not necessarily imply that they are embodied on separate servers or devices. As such, for example, a single server or device may include both entities and the database server 42 could merely be represented by a database or group of databases physically located on the same server or device as the application server 40. The application server 40 and the database server 42 may each include hardware and/or software for configuring the application server 40 and the database server 42, respectively, to perform various functions. As such, for example, the application server 40 may include processing logic and memory enabling the application server 40 to access and/or execute stored computer readable instructions for performing various functions. In an example embodiment, one function that may be provided by the application server 40 may be the provision of access to information and/or services related to operation of the clients 20. For example, the application server 40 may be configured to provide for storage of information descriptive of motion or location. In some cases, these contents may be stored in the database server 42. Alternatively or additionally, the application server 40 may be configured to provide analytical tools for use by the clients 20 in accordance with example embodiments.

In some embodiments, for example, the application server 40 may therefore include an instance of an subject locator module 44 comprising stored instructions for handling activities associated with practicing example embodiments as described herein. As such, in some embodiments, the clients 20 may access the subject locator module 44 online and utilize the services provided thereby. However, it should be appreciated that in other embodiments, the subject locator module 44 may be initiated from an integrated memory of the client 20. In some example embodiments, the subject locator module 44 may be provided from the application server 40 (e.g., via download over the network 30) to one or more of the clients 20 to enable recipient clients to instantiate an instance of the subject locator module 44 for local operation. As yet another example, the subject locator module 44 may be instantiated at one or more of the clients 20 responsive to downloading instructions from a removable or transferable memory device carrying instructions for instantiating the subject locator module 44 at the corresponding one or more of the clients 20. In such an example, the network 30 may, for example, be a peer-to-peer (P2P) network where one of the clients 20 includes an instance of the subject locator module 44 to enable the corresponding one of the clients 20 to act as a server to other clients 20. In a further example embodiment, the subject locator module 44 may be distributed amongst one or more clients 20 and/or the application server 40.

In an example embodiment, the application server 40 may include or have access to memory (e.g., internal memory or the database server 42) for storing instructions or applications for the performance of various functions and a corresponding processor for executing stored instructions or applications. For example, the memory may store an instance of the subject locator module 44 configured to operate in accordance with an example embodiment of the present invention. In this regard, for example, the subject locator module 44 may include software for enabling the application server 40 to communicate with the network 30 and/or the clients 20 for the provision and/or receipt of information associated with performing activities as described herein. Moreover, in some embodiments, the application server 40 may include or otherwise be in communication with an access terminal (e.g., a computer including a user interface) via which analysts may interact with, configure or otherwise maintain the system 10.

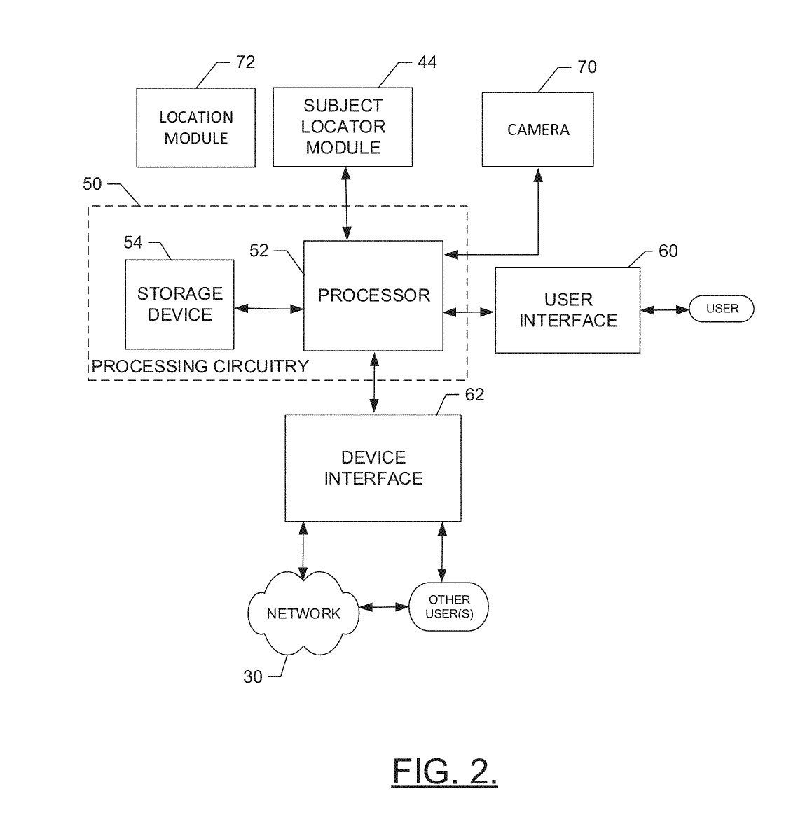

An example embodiment will now be described with reference to FIG. 2. FIG. 2 shows certain elements of an apparatus for causing a target inventory query based on content within an image according to an example embodiment. The apparatus of FIG. 2 may be employed, for example, on a client (e.g., any of the clients 20 of FIG. 1) or a variety of other devices (such as, for example, a network device, server, proxy, or the like (e.g., the application server 40 of FIG. 1)). Alternatively, embodiments may be employed on a combination of devices. Accordingly, some embodiments of the present invention may be embodied wholly at a single device (e.g., the application server 40 or one or more clients 20) or by devices in a client/server relationship (e.g., the application server 40 and one or more clients 20). Furthermore, it should be noted that the devices or elements described below may not be mandatory and thus some may be omitted in certain embodiments.

Referring now to FIG. 2, an apparatus configured for causing a target inventory query based on content within an image is provided. The apparatus may be an embodiment of the subject locator module 44 or a device hosting the subject locator module 44. As such, configuration of the apparatus as described herein may transform the apparatus into the subject locator module 44. In an example embodiment, the apparatus may include or otherwise be in communication with processing circuitry 50 that is configured to perform data processing, application execution and other processing and management services according to an example embodiment. In one embodiment, the processing circuitry 50 may include a storage device 54 and a processor 52 that may be in communication with or otherwise control a user interface 60 and a device interface 62. As such, the processing circuitry 50 may be embodied as a circuit chip (e.g., an integrated circuit chip) configured (e.g., with hardware, software or a combination of hardware and software) to perform operations described herein. However, in some embodiments, the processing circuitry 50 may be embodied as a portion of a server, computer, laptop, workstation or even one of various security devices. In situations where the processing circuitry 50 is embodied as a server or at a remotely located computing device, the user interface 60 may be disposed at another device (e.g., at a computer terminal or client device such as one of the clients 20) that may be in communication with the processing circuitry 50 via the device interface 62 and/or a network (e.g., network 30).

The user interface 60 may be in communication with the processing circuitry 50 to receive an indication of a user input at the user interface 60 and/or to provide an audible, visual, mechanical or other output to the user. As such, the user interface 60 may include, for example, a keyboard, a mouse, a joystick, a display, a touch screen, a microphone, a speaker, a cell phone, or other input/output mechanisms. In embodiments where the apparatus is embodied at a server or other network entity, the user interface 60 may be limited or even eliminated in some cases. Alternatively, as indicated above, the user interface 60 may be remotely located.

The device interface 62 may include one or more interface mechanisms for enabling communication with other devices and/or networks. In some cases, the device interface 62 may be any means such as a device or circuitry embodied in either hardware, software, or a combination of hardware and software that is configured to receive and/or transmit data from/to a network and/or any other device or module in communication with the processing circuitry 50. In this regard, the device interface 62 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In situations where the device interface 62 communicates with a network, the network may be any of various examples of wireless or wired communication networks such as, for example, data networks like a Local Area Network (LAN), a Metropolitan Area Network (MAN), and/or a Wide Area Network (WAN), such as the Internet.

In an example embodiment, the storage device 54 may include one or more non-transitory storage or memory devices such as, for example, volatile and/or non-volatile memory that may be either fixed or removable. The storage device 54 may be configured to store information, data, applications, instructions or the like for enabling the apparatus to carry out various functions in accordance with example embodiments. For example, the storage device 54 could be configured to buffer input data for processing by the processor 52. Additionally or alternatively, the storage device 54 could be configured to store instructions for execution by the processor 52. As yet another alternative, the storage device 54 may include one of a plurality of databases (e.g., database server 42) that may store a variety of files, contents or data sets. Among the contents of the storage device 54, applications (e.g., client application 22 or service application 42) may be stored for execution by the processor 52 in order to carry out the functionality associated with each respective application.

The processor 52 may be embodied in a number of different ways. For example, the processor 52 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an example embodiment, the processor 52 may be configured to execute instructions stored in the storage device 54 or otherwise accessible to the processor 52. As such, whether configured by hardware or software methods, or by a combination thereof, the processor 52 may represent an entity (e.g., physically embodied in circuitry) capable of performing operations according to embodiments of the present invention while configured accordingly. Thus, for example, when the processor 52 is embodied as an ASIC, FPGA or the like, the processor 52 may be specifically configured hardware for conducting the operations described herein. Alternatively, as another example, when the processor 52 is embodied as an executor of software instructions, the instructions may specifically configure the processor 52 to perform the operations described herein.

In an example embodiment, the processor 52 (or the processing circuitry 50) may be embodied as, include or otherwise control the subject locator module 44, which may be any means, such as, a device or circuitry operating in accordance with software or otherwise embodied in hardware or a combination of hardware and software (e.g., processor 52 operating under software control, the processor 52 embodied as an ASIC or FPGA specifically configured to perform the operations described herein, or a combination thereof) thereby configuring the device or circuitry to perform the corresponding functions of the subject locator module 44 as described below.

The subject locator module 44 may include tools to facilitate causing a target inventory query based on content, e.g., a subject or item, within an image via the client 20, server network 32, network 30, or a combination thereof. In an example embodiment the subject locator module 44 may be configured for receiving an image including at least one subject, extracting features of the at least one subject from the image, determining a subject identity based on the features, receiving a user location indication, and causing, by processing circuitry, a target inventory query to be transmitted based on the subject identity and the user location indication.

In some embodiments, the subject locator module 44 may further include one or more components or modules that may be individually configured to perform one or more of the individual tasks or functions generally attributable to the subject locator module 44. However, the subject locator module 44 need not necessarily be modular. In cases where the subject locator module 44 employs modules, the modules may, for example, be configured for causing a target inventory query based on a subject within an image, as described herein. In some embodiments, the subject locator module 44 and/or any modules comprising the subject locator module 44 may be any means such as a device or circuitry operating in accordance with software or otherwise embodied in hardware or a combination of hardware and software (e.g., processor 52 operating under software control, the processor 52 embodied as an ASIC or FPGA specifically configured to perform the operations described herein, or a combination thereof) thereby configuring the device or circuitry to perform the corresponding functions of the subject locator module 44 and/or any modules thereof, as described herein.

In some example embodiments, the apparatus may include a camera 70. The camera may be configured to capture still or moving images. In some embodiments the camera 70 may be a digital camera and the captured image or images may be stored in a memory, such as storage device 54.

In an example embodiment, the apparatus may include a location module 72. The location module 72 may be configured to determine a location of the apparatus. In an example embodiment, the location module 72 may be a global positioning sensor, a radio frequency sensor, a ring laser gyro, or the like.

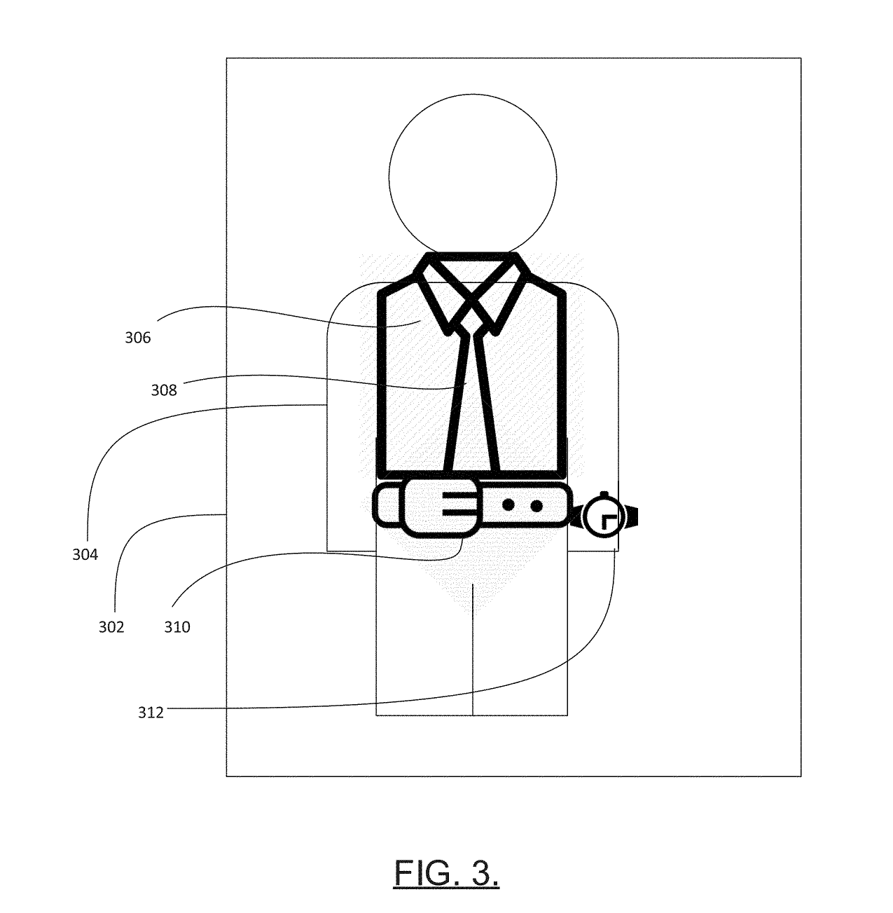

FIG. 3 illustrates an example image including a subject according to an example embodiment. An apparatus such as, client 20 may receive an image 302. The image 302 may be received from the camera 70 in an instance in which the user captures an image 302, or from a memory, such as storage device 54, in an instance in which the image has been previously captured and stored. Additionally or alternatively, the image 302 may be received from the device interface 62, such as in an instance in which the image 302 is from a remote source, such as an internet site, digital book, digital publication, movie, video, or the like. The image 302 may include one or more persons 304, and one or more subjects 306, 308, 310, 312, e.g., an item of interest, such as clothing, accessories, products, or the like. Although, the example subjects discussed herein are directed toward clothing and personal items, the process may be used for any identifiable subject, such as a car, furniture, paintings, or the like. In the example image 302 the subjects include a shirt 304, a tie 308, a belt 310, and a watch 312.

In an example embodiment, one of the subjects 306, 308, 310, 312 within the image 302 may be selected by the user through interaction with the user interface 60. The selection may be a click, circle, tap, or the like, on, near, or around the selected one of the subjects 306, 308, 310, 312. The processing circuitry 50 may receive an indication of a selected subject 306, 308, 310, 312 from the user interface 60.

The processing circuitry 50 may extract features from selected subject 306, 308, 310, 312 (or from all the subjects 306, 308, 310, 312 of the image 302). In an example embodiment in which an indication of a selected subject 306, 308, 310, 312 is received, the processing circuitry 50 may extract only the features associated with the selected subject 306, 308, 310, 312. The feature extraction may include one or more of edge detection, corner detection, blob, detection, ridge detection, Hough transformation, structure tensor, affine invariant feature detection, or the like. The extracted features may include outlines, shapes, patterns, colors, or the like.

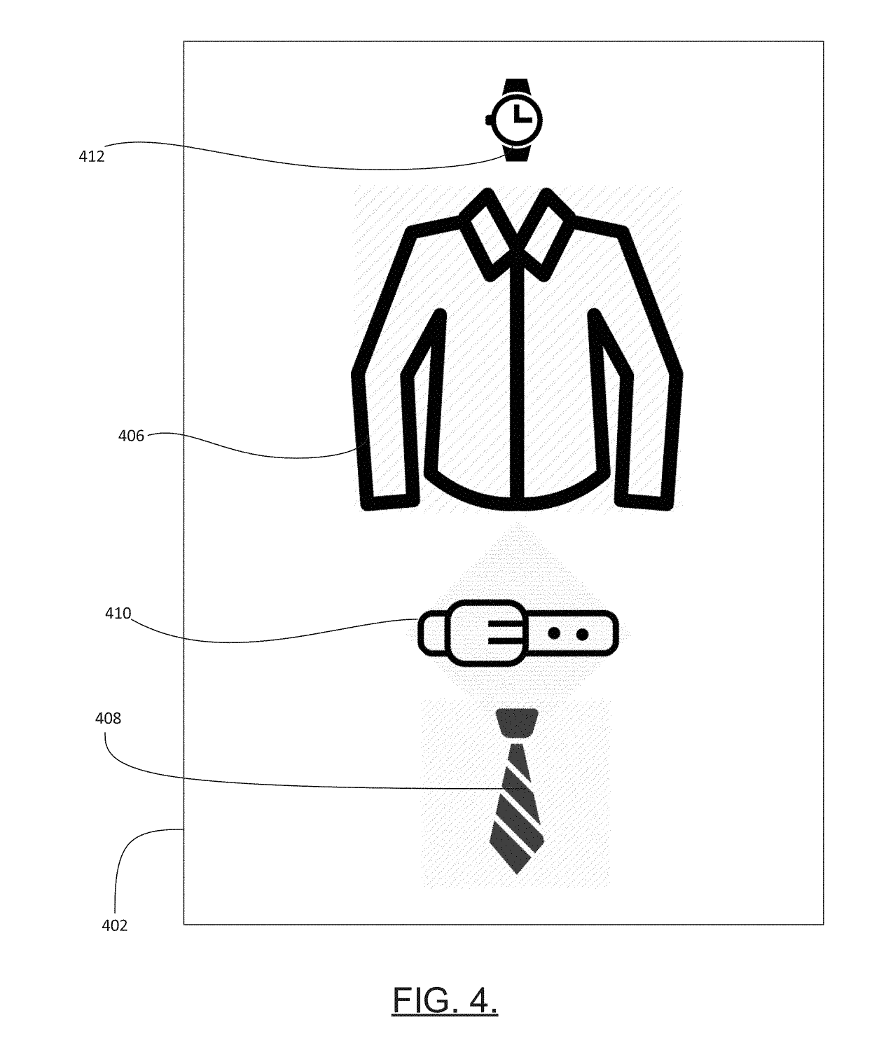

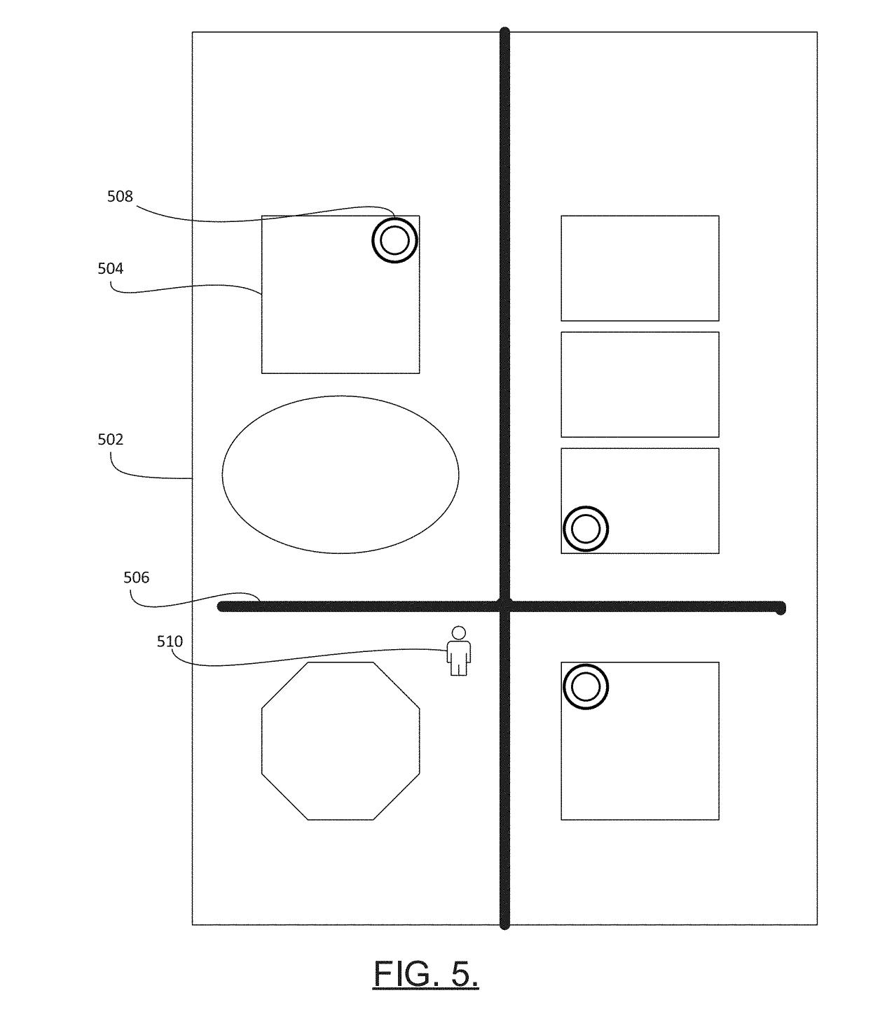

In some example embodiments, subject features of one or more subjects 306, 308, 310, 312 may be extracted, and then an option for selecting a subject 306, 308, 310, 312 may be presented, such as highlighting the subjects which may be selected or displaying only the selectable subjects. For example the selectable subjects may be presented in a selection menu 402, as depicted in FIG. 4. The selection menu may be rendered in the same display area as the image 302 or in a separate display area, such as next to the image or in a new tab or pane. In the depicted example, the selectable subjects include a shirt 406, a tie 408, belt 410, and watch 412. The selectable subjects 406, 408, 410, 412 may be displayed in a text format, list format, picture format, or the like.

The processing circuitry 50 may generate a subject identity query based on the selected subject. The subject identity query may include the extracted features of the one or more subjects 306, 308, 310, 312 or selected subjects. The processing circuitry 50 may cause a transmission of the subject identity query to server, such as server network 32, or may locally process the subject identity query. The extracted features of the subject identity query may be used to request or access identity query results, for example features which may be associated with a shirt, a color, and/or a style of cut of the shirt may be used to request or access product identifiers and features associated with the product items. The features associated with the product items may be extracted by retailers and/or manufactures and stored in a database for target analysis, such as database server 42.

One or more product item identifiers and features associated with the product identifiers may be received as a subject identity query result. The features of the one or more product identifiers of the subject identity query result may be compared to the extracted features of the subjects 306, 308, 310, 312 or selected subjects. The similarities or matches between the features associated with the product identifiers and features of the subjects 306, 308, 310, 312 or selected subjects may be used to determined a probability score for each product identifier, for example a percentage of matched features, or a number of matches or variances.

The processing circuitry 50 may use the probability score may to determine a “target,” e.g., target product, such as a product item that is most probably the subject or that most closely correlates to the subject. In one embodiment, the probability score may be compared to a predetermined probability threshold. In an instance in which the probability score satisfies the probability threshold, such as greater than 80 percent probability, the target product may be determined to be the at least one probable subject. In an instance in which the probability score for a product item fails to satisfy the probability threshold, such as failing to be greater then 75 percent probability, the target product may be indeterminate, or list of one or more product items having the highest probability score may be returned.

In an example embodiment, one or more probable subject identities may be caused to be displayed, such as on the user interface 60 by the processing circuitry 50. The probable subject identities may be rendered to identify the probability score, such as descending order, color coded, or the like.

In some example embodiments, the processing circuitry 50 may receive bid information, from one or more retailers or manufacturers. The bid information may be one or more biasing factors based on a monetary value paid or offered by the retailer or manufacturer. For example, the bid information may be a probability score bias, such as 1 point, 10 percent, or the like, which may be added or subtracted from a probability score associated with one or more product identifiers. The probability score bias may alter the position in which the biased product identifier is rendered with the probable subject identities.

The processing circuitry 50 may determine a subject identity by selection of a product identifier from the at least one probable subject identity. In an example embodiment, the processing circuitry 50 may determine the probable subject identity, such as the top, e.g., most probable, subject identity or when only one probable subject identity is present. In some example embodiments, the user may select a product identity by interacting with the user interface 60, such as taping, clicking, circling, or the like. The user interface 60 may transmit a user selection indication to the processing circuitry 50, in response to the user selection. In an example embodiment, two or more subject identities may be determined, such as the top two probability scored product identifiers.

The processing circuitry 50 may receive a user location indication from the user interface 60 and/or a location module 72. The location module 72 may provide a current location based on one or more positioning systems, such as global positioning. The user interface 60 may receive user input such as an address, a map point selection, or the like, indicating the user location.

The processing circuitry 50 may cause the device interface 62 to transmit a target inventory query based on the selected subject identity or identities and the user location. The target inventory query may include a radius associated with the user location, such as ¼ mile, 5, miles, 40 miles, or the like. The radius may be selected by the user via the user interface 60. In some embodiments, the radius may be automatically determined by the processing circuitry 50, based on mode of travel, environment, e.g., rural or urban (an indication of retailer density), or he like. Additionally or alternatively, the radius may be automatically determined and adjusted by the user.

The inventory of product identifiers may be stored in one or more databases, such as database server 42, including the inventory of one or more product identifiers at a retailer or merchant. The processing circuitry 50 may query inventory databases which include product identifier inventories for locations within the radius of the user location. The processing circuitry 50 may receive at least one target inventory result; from the one or more inventory databases, indicating that the retailer or merchant associated with the target inventory result has indicated at least one of the target in inventory. The target inventory result may include the quantity of a target item, the location information of the retailer or merchant, or the like.

The processing circuitry 50 may cause location of the target, e.g., address, may be displayed on the user interface 60. Additionally or alternatively, the processing circuitry 50 may render the location of one or more targets on a map rendering, such as map rendering 502. The map rendering 502 may include landmarks 506, such as streets, structures, parks, or the like. The target locations 508 may be depicted at or near the location information. In some embodiments, the map rendering 502 may include building outlines 504. The target locations 508 may be rendered, in some instances, at an approximate position, of the retailer, merchant, or target product, within the building. In some instance such as a large retailer, or mall, the map rendering may be the layout of the inside of a building and identify the approximate position of the target item within the building. The map rendering may additionally include the user location 510.

In some example embodiments, the target locations 508 may be differentiated by the subject identity, such as when two or more product identifiers where selected as the subject identity. In an example embodiment, the target locations 508 associated with a first product identifier may be a first color, shape, size or the like, and target locations 508 associated with a second product identifier, may be a second color shape, size, or the like. In an example embodiment, in which a target location 508 is associated with multiple product identifiers, the target location 508 may be a third color shape or size.

In an example embodiment, the map rendering may be adjusted based on the bid information, for example, a target location associated with bid information may be rendered larger, or in a different color than other target locations.

The target location 508 may be selectable in one or more embodiment, which may cause the processing circuitry 50 to render retail information. The retail information may be associated with the target inventory result. The retail information may be requested and received by the processing circuitry 50 from a database, such as the inventory database, in response to the selection of the target location, with the reception of the target inventory results (in conjuction with or a as portion thereof), or the like.

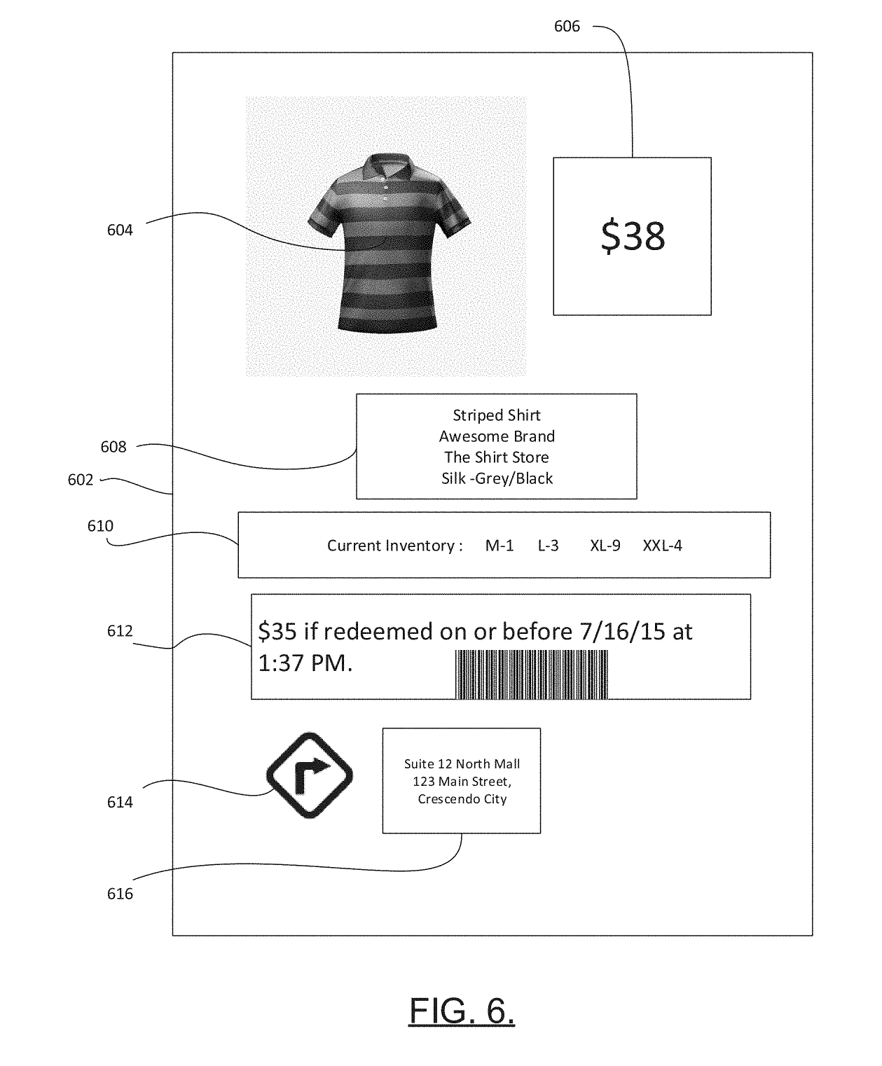

As illustrated in FIG. 6, the retail information 602 may be displayed on a user interface 60. The retail information 602 may include a picture, video, or other rendering of the target 604, which is a shirt in the depicted example. The retail information 602 may also have a description of the target 608, including product information such a name of the product “striped shirt”; a brand or manufacturer “Awesome Brand”; name of the retailer “The Shirt Store”; material, color “Silk-Grey/Black”; or the like. The retail information may include a price of the target 606, such as 38 dollars.

The retail information 602 may include the quantity of inventory of the target at the retail location. In an instance in which the target may have options, such as size or color, the quantity in inventory, an inventory information report 610 may be generated to provide information specific to the options, such as 1 medium, 3 large, 9 extra large, and 4 extra extra large. However, the inventory information report may also be generated in each instance in which retail information 602 is provided.

In an example embodiment, the retail information 602 may include an address 606 of the retailer Suite 12 North Mall, 123 Main Street, Crescendo City”. Additionally or alternatively, the retail information 602 may include directions or a turn by turn navigation link 614, configured to provide directions based on the retailer address 616 or location 508 and the user location 510.

In an example embodiment, a redemption coupon 612 may be provided. The redemption coupon 612 may be generated based on the bid information. The redemption coupon 612 may be displayed in the same or different viewing area as the retail information 602, on the user interface 60. The redemption coupon 612 may be a reduced price, such as a percentage, set price, value off retail price or the like. For example, the redemption coupon 612 may provide for 35 dollars at redemption instead of the 38 dollar price. In some example embodiments, the redemption coupon 612 may have an expiration date. The expiration date may be based on a current time of viewing the target, value of the target, distance between the retailer location 508 and the user location 510, or the like, such as 2 hours, 2 days, 60 days, or the like. In some example embodiments, the redemption coupon 612 may include a unique identifier such as a bar code, quick response (QR) code, or the like, which may be used for validation of the offer. In an example embodiment, the retail location 508 associated with a redemption coupon 612 may be rendered to differentiate the indicator, such as a different shape, size or color.

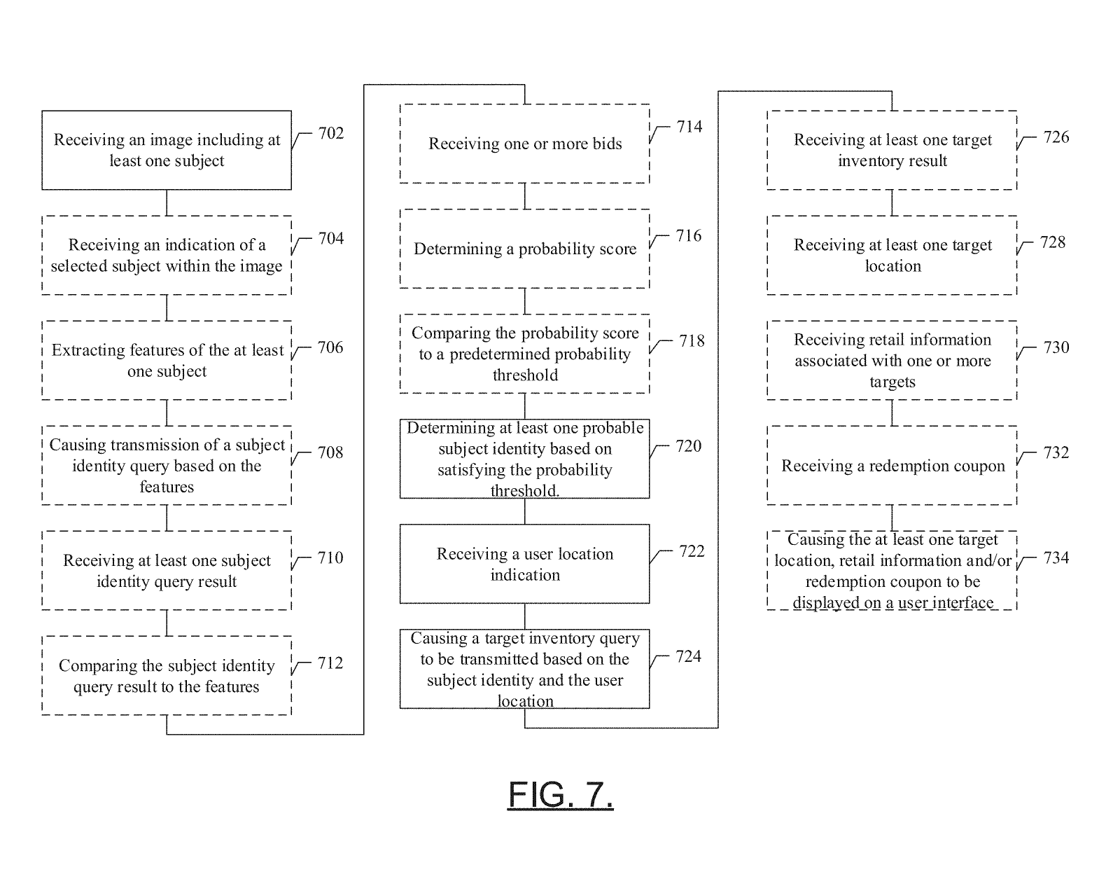

From a technical perspective, the subject locator module 44 described above may be used to support some or all of the operations described above. As such, the platform described in FIG. 2 may be used to facilitate the implementation of several computer program and/or network communication based interactions. As an example, FIG. 7 is a flowchart of a method and program product according to an example embodiment. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a user terminal (e.g., client 20, application server 40, and/or the like) and executed by a processor in the user terminal. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one example embodiment is shown in FIG. 7. The method may be employed for a multi-step selection interface. The method may include, receiving an image including at least one subject, at operation 702. The method may also include extracting features of the at least one subject, at operation 706. At operation 720, the method may include determining at least one probable subject identity based on the features and receiving a user location indication, at operation 722. The method, at operation 724, may include causing a target inventory query to be transmitted based on the subject identity and the user location.

In an example embodiment, the method may optionally include, as denoted by the dashed box, operation 704 receiving an indication of a selected subject within the image. The method may also optionally include causing transmission of the subject identity query based on the features, at operation 708, or receiving at least one subject identity query result, at operation 710. In an example embodiment, the method may include comparing the subject identity query results to the features, at operation 712, or receiving one or more bids, at operation 714. In some example embodiments, the method may also include determining a probability score, at operation 716, and comparing the probability score to a predetermined probability threshold, at operation 718. In an example embodiment, the method may include receiving at least one target inventory result, at operation 726, or receiving at least one target location, at operation 728. In some example embodiments, the method may include receiving retail information associated with the one or more targets, at operation 730, or receiving a redemption coupon, at operation 732. In an example embodiment, the method may also include causing the at least one target location, retail information and/or a redemption coupon to be displayed on a user interface.

In an example embodiment, an apparatus for performing the method of FIG. 7 above may comprise a processor (e.g., the processor 52) or processing circuitry configured to perform some or each of the operations (702-734) described above. The processor may, for example, be configured to perform the operations (702-734) by performing hardware implemented logical functions, executing stored instructions, or executing algorithms for performing each of the operations. In some embodiments, the processor or processing circuitry may be further configured for additional operations or optional modifications to operations 702-734. In this regard, for example, the method also includes receiving at least one target inventory result comprising a target identity and target location. In an example embodiment, the method also includes causing at least one target location of the at least one target inventory result to be displayed on a user interface. In some example embodiment, the method also includes receiving retail information associated with the at least one target inventory and causing the retail information to be displayed on a user interface. In an example embodiment, the method also includes receiving an indication of a selected subject within the image and the extracting also includes extracting features of the selected subject. In some example embodiments, causing transmission of a subject identity query based on the features and receiving a subject identity query result. In an example embodiment, the determining the subject identity also includes comparing the subject identity query result and the features, determining a probability score based on the comparison of the subject identity query result and the features, and determining at least one probable subject identity based on the probability score. In some example embodiments, determining the probability score also includes receiving one or more bids. The one or more bids bias the probability score. In an example embodiment, the determining the at least one probable subject also includes comparing the probability score to a probability threshold and determining the at least one probable subject identity based on satisfying the probability threshold. In some example embodiments, the method also includes receiving a redemption coupon comprising an article identity, a redemption price, and a redemption period.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. An apparatus comprising processing circuitry configured to:
receive an image including at least one subject;
extract features of the at least one subject from the image;
determine a subject identity based on the features;
receive a user location indication; and
cause a target inventory query to be transmitted based on the subject identity and the user location indication.

2. The apparatus of claim 1, wherein the processing circuitry is further configured to:
receive at least one target inventory result comprising a target identity and a target location.

3. The apparatus of claim 2, wherein the processing circuitry is further configured to:
cause at least one target location of the at least one target inventory result to be displayed on a user interface.

4. The apparatus of claim 2, wherein the processing circuitry is further configured to:
receive retail information associated with the at least one target inventory result; and
cause the retail information to be displayed on a user interface.

5. The apparatus of claim 1, wherein the processing circuitry is further configured to:
receive an indication of a selected subject within the image, and
wherein extracting features comprises extracting features of the selected subject.

6. The apparatus of claim 1, wherein determining the subject identity comprises:
causing a subject identity query based on the features; and
receiving a subject identity query result.

7. The apparatus of claim 6, wherein determining the subject identity further comprises:
comparing the subject identity query result and the features;
determining a probability score based on the comparison of the subject identity query result and the features; and
determining at least one probable subject identity based on the probability score.

8. The apparatus of claim 7, wherein determining the probability score further comprises:
receiving one or more bids;
wherein the one or more bids bias the probability score.

9. The apparatus of claim 7, wherein the determining the at least one probable subject identity further comprises:
comparing the probability score to a probability threshold; and
determining the at least one probable subject identity based on satisfying the probability threshold.

10. The apparatus of claim 1, wherein the processing circuitry is further configured to:
receive a redemption coupon comprising an article identity, a redemption price, and a redemption period.

11. A method comprising:
receiving an image including at least one subject;
extracting features of the at least one subject from the image;
determining a subject identity based on the features;
receiving a user location indication; and
causing, by processing circuitry, a target inventory query to be transmitted based on the subject identity and the user location indication.

12. The method of claim 11, further comprising:
receiving at least one target inventory result comprising a target identity and a target location.

13. The method of claim 12 further comprising:
causing at least one target location of the at least one target inventory result to be displayed on a user interface.

14. The method of claim 12 further comprising:
receiving retail information associated with the at least one target inventory result; and
causing the retail information to be displayed on a user interface.

15. The method of claim 11 further comprising:
receiving an indication of a selected subject within the image, and
wherein extracting features comprises extracting features of the selected subject.

16. The method of claim 11, wherein determining the subject identity comprises:
causing a subject identity query based on the features; and
receiving a subject identity query result.

17. The method of claim 16, wherein determining the subject identity further comprises:
comparing the subject identity query result and the features;
determining a probability score based on the comparison of the subject identity query result and the features; and
determining at least one probable subject identity based on the probability score.

18. The method of claim 17, wherein determining the probability score further comprises:
receiving one or more bids;
wherein the one or more bids bias the probability score.

19. The method of claim 17, wherein the determining the at least one probable subject identity further comprises:
comparing the probability score to a probability threshold; and
determining the at least one probable subject identity based on satisfying the probability threshold.

20. The method of claim 11 further comprising:
receiving a redemption coupon comprising an article identity, a redemption price, and a redemption period.
